(19) United States
(12) Patent Application Publication
(10) Pub. No.: US 2026/0333115 A1
(43) Pub. Date: Oct. 22, 2026

(54) Reflective Quality of Service Rule Management

(71) Applicant: Apple Inc., Cupertino, CA (US)

(72) Inventors: Amit DUBEY, San diego, CA (US); Martin KUGLER, Poing (DE); Vijay VENKATARAMAN, San Jose, CA (US)

(21) Appl. No.: 19/113,068

(22) PCT Filed: Sep. 12, 2023
(86) PCT No.: PCT/US2023/032489

§ 371 Date: Mar. 19, 2025

Related U.S. Application Data
(60) Provisional application No. 63/376,464, filed on Sep. 21, 2022.

(51) Int. Cl. H04W 28/02

(52) U.S. Cl. CPC H04W 28/0268

(57) ABSTRACT

A user equipment (UE) configured to derive a first quality of service (QoS) rule for reflective QoS based on received downlink traffic, add the first QoS rule to a list of at least one QoS rules, wherein the list is associated with a timer and the timer is configured to indicate when a QoS rule timeout has occurred, derive a second QoS rule for reflective QoS based on the received downlink traffic and add the second QoS rule to the list, wherein the second QoS rule is associated with a timeout value that is defined relative to one or more QoS rules included in the list.

### PRIORITY/INCORPORATION BY REFERENCE

This application claims priority to U.S. Provisional Application Ser. No. 63/376,464 filed on Sep. 21, 2022 and entitled “Reflective Quality of Service Rule Management,” the entirety of which is incorporated herein by reference.

### BACKGROUND

Reflective quality of service (QoS) may enable a user equipment (UE) to derive QoS rules for uplink traffic based on received downlink traffic. The UE may then use the derived QoS rules to determine a mapping of uplink traffic to QoS flows.

### SUMMARY

Some exemplary embodiments are related to an apparatus of a user equipment (UE), the apparatus having processing circuitry configured to derive a first quality of service (QoS) rule for reflective QoS based on received downlink traffic, add the first QoS rule to a list of at least one QoS rules, wherein the list is associated with a timer and the timer is configured to indicate when a QoS rule timeout has occurred, derive a second QoS rule for reflective QoS based on the received downlink traffic and add the second QoS rule to the list, wherein the second QoS rule is associated with a timeout value that is defined relative to one or more QoS rules included in the list.

Other exemplary embodiments are related to an apparatus of a user equipment (UE), the apparatus having processing circuitry configured to derive a first quality of service (QoS) rule for reflective QoS based on received downlink traffic and add the first QoS rule to a list of at least one QoS rules with a timestamp for the first QoS rule, wherein the list comprises one or more QoS rules each with a respective timestamp and none of the one or more QoS rules are associated with a timer configured to indicate when a timeout has occurred.

### BRIEF DESCRIPTION OF THE DRAWINGS

FIG. 1 shows an exemplary arrangement according to various exemplary embodiments.

FIG. 2 shows an exemplary user equipment (UE) according to various exemplary embodiments.

FIG. 3 shows an exemplary base station according to various exemplary embodiments.

FIG. 4 shows an example of utilizing a smart reflective quality of service (SRQ) timer and a shortest timer first (STF) list for quality of service (QoS) rule management according to various exemplary embodiments.

FIG. 5 shows a method for processing downlink packets according to various exemplary embodiments.

FIGS. 6a-6b show an example of utilizing the SRQ timer and the STF list for QoS rule management according to various exemplary embodiments.

FIG. 7 shows a method for a timestamp-based approach for QoS management.

FIG. 8 shows an example of managing a QoS rule list using a timestamp-based approach according to various exemplary embodiments.

### DETAILED DESCRIPTION

The exemplary embodiments may be further understood with reference to the following description and the related appended drawings, wherein like elements are provided with the same reference numerals. The exemplary embodiments relate to reflective quality of service (QoS).

The exemplary embodiments are described with regard to a user equipment (UE). However, reference to the term UE is merely provided for illustrative purposes. The exemplary embodiments may be utilized with any electronic component that may establish a connection to a network and is configured with the hardware, software, and/or firmware to exchange information and data with the network. Therefore, the UE as described herein is used to represent any appropriate type of electronic component.

The exemplary embodiments are also described with regard to a fifth generation (5G) New Radio (NR) network. However, reference to a 5G NR network is merely provided for illustrative purposes. The exemplary embodiments may be applied to any appropriate type of network that supports reflective QoS.

Those skilled in the art will understand that reflective QoS may enable the UE to map uplink traffic to QoS flows without the network explicitly providing QoS rules to the UE. Instead, the UE may derive QoS rules for uplink traffic based on received downlink traffic. The UE may then use the derived QoS rules to determine a mapping of uplink traffic to QoS flows. From the perspective of the UE, a QoS rule may include at least an uplink packet filter. Accordingly, throughout this description, the terms “filter” and “QoS rule” may be used interchangeably to generally refer to a UE derived QoS rule for reflective QoS.

Under some circumstances, the UE may associate each derived QoS rule with a reflective QoS timer. When a particular QoS rule is identified from downlink traffic, the UE may start a corresponding reflective QoS timer. Each time the QoS rule is identified in subsequent downlink traffic, the corresponding reflective QoS timer may be restarted. When the reflective QoS timer expires, the UE may delete the corresponding QoS rule from its local database. However, a UE may only have a limited number of timers available to be used for maintaining QoS rules and in certain scenarios, the UE may run out of available timers to utilize for QoS rule management. In addition, the processing required to operate a timer for each QoS rule may have a negative impact on performance (e.g., downgrade throughput, increase million instructions per second (MIPS), etc.). Accordingly, it has been identified that there is a need to improve the manner in which QoS rules for reflective QoS are maintained by the UE.

In one aspect, the exemplary embodiments introduce a smart reflective QoS (SRQ) timer that may be associated with multiple QoS rules. Thus, in contrast to the approach described above where a single timer is associated with a single QoS rule, a single SRQ timer may be used to manage multiple QoS rules. However, reference to the term “SRQ timer” is merely provided for illustrative purposes, different entities may refer to a similar concept by a different name.

According to other aspects, the exemplary embodiments introduce a timestamp-based approach for managing QoS rules. Thus, instead of relying on one or more timers to manage a local database of QoS rules for reflective QoS, the UE may compare timestamps to determine whether a QoS rule is to be maintained. Each of these exemplary aspects are described in detail below.

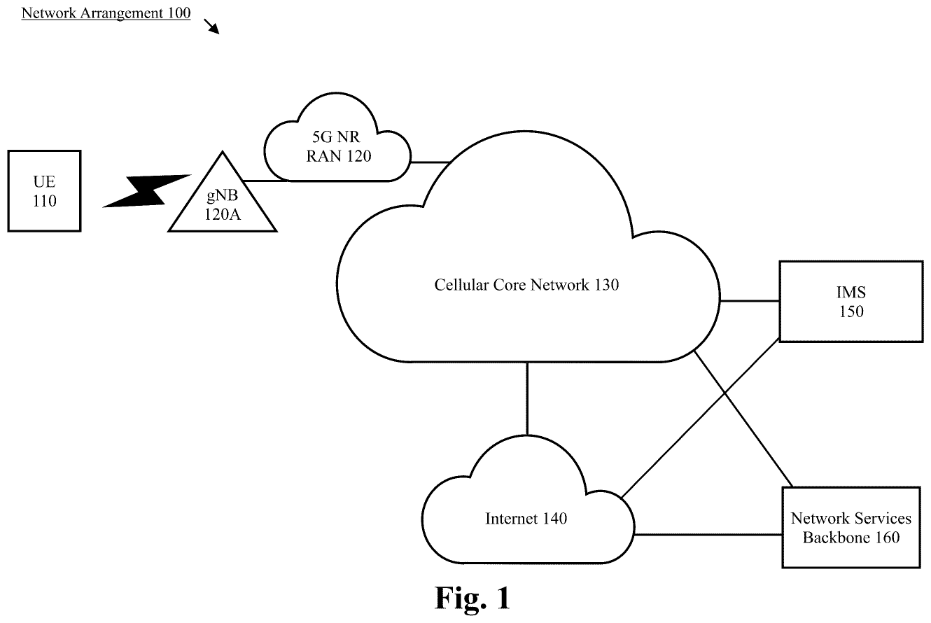

FIG. 1 shows an exemplary network arrangement 100 according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IoT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network arrangement 100, the network with which the UE 110 may wirelessly communicate is a 5G NR radio access network (RAN) 120. However, the UE 110 may also communicate with other types of networks (e.g., a sixth generation (6G) network, a 5G cloud RAN, a next generation RAN (NG-RAN), a long-term evolution (LTE) RAN, a legacy cellular network, a wireless local area network (WLAN), etc.) and the UE 110 may also communicate with networks over a wired connection. With regard to the exemplary embodiments, the UE 110 may establish a connection with the 5G NR RAN 120. Therefore, the UE 110 may have at least a 5G NR chipset to communicate with the 5G NR RAN 120.

The 5G NR RAN 120 may be a portion of a cellular network that may be deployed by a network carrier (e. g., Verizon, AT&T, T-Mobile, etc.). The 5G NR RAN 120 may include, for example, base stations or access nodes (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

Those skilled in the art will understand that any association procedure may be performed for the UE 110 to connect to the 5G NR RAN 120. For example, as discussed above, the 5G NR RAN 120 may be associated with a particular cellular provider where the UE 110 and/or the user thereof has a contract and credential information (e.g., stored on a subscriber identity module (SIM) card). Upon detecting the presence of the 5G NR RAN 120, the UE 110 may transmit the corresponding credential information to associate with the 5G NR RAN 120. More specifically, the UE 110 may associate with a specific base station, e.g., the gNB 120A.

The network arrangement 100 also includes a cellular core network 130, the Internet 140, an IP Multimedia Subsystem (IMS) 150, and a network services backbone 160. The cellular core network 130 may refer an interconnected set of components that manages the operation and traffic of the cellular network. It may include the evolved packet core (EPC) and/or the 5G core (5GC). The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

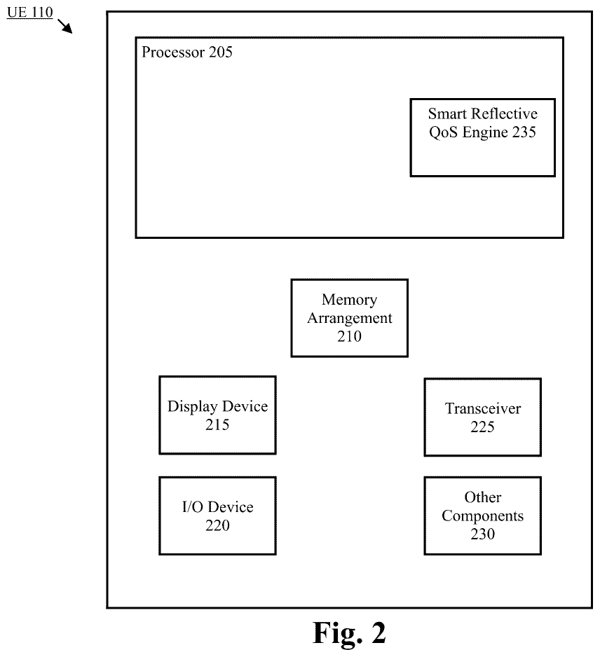

FIG. 2 shows an exemplary UE 110 according to various exemplary embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 230 may include, for example, an audio input device, an audio output device, a power supply, a data acquisition device, ports to electrically connect the UE 110 to other electronic devices, etc.

The processor 205 may be configured to execute a plurality of engines of the UE 110. For example, the engines may include a smart reflective QoS engine 235. The smart reflective QoS engine 235 may perform various operations such as, but not limited to, extracting filter information from downlink traffic, maintaining a database of QoS rules, operating one or more timers, recording timestamps and comparing timestamps.

The above referenced engine 235 being an application (e.g., a program) executed by the processor 205 is merely provided for illustrative purposes. The functionality associated with the engine 235 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engine may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen.

The transceiver 225 may be a hardware component configured to establish a connection with the 5G-NR RAN 120, an LTE-RAN (not pictured), a legacy RAN (not pictured), a 5G-advanced RAN (not pictured), a 6G RAN (not pictured), a WLAN (not pictured), etc. Accordingly, the transceiver 225 may operate on a variety of different frequencies or channels (e.g., set of consecutive frequencies). The transceiver 225 includes circuitry configured to transmit and/or receive signals (e.g., control signals, data signals). Such signals may be encoded with information implementing any one of the methods described herein. The processor 205 may be operably coupled to the transceiver 225 and configured to receive from and/or transmit signals to the transceiver 225. The processor 205 may be configured to encode and/or decode signals (e.g., signaling from a base station of a network) for implementing any one of the methods described herein.

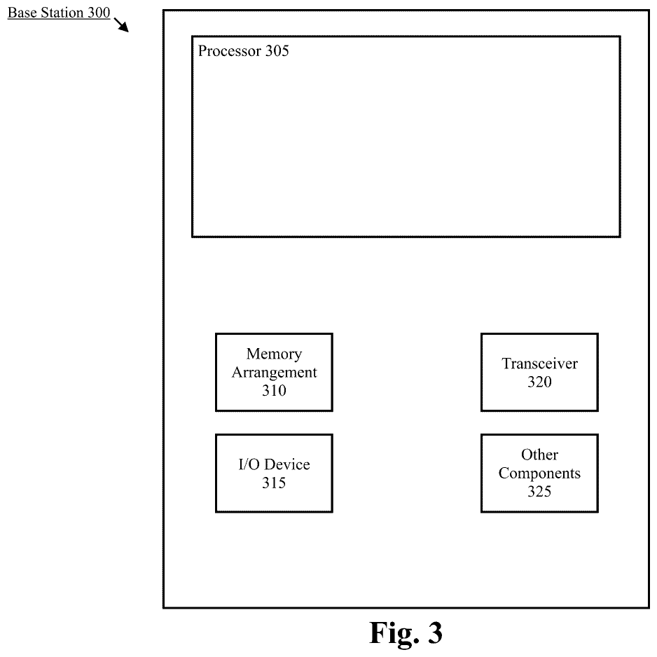

FIG. 3 shows an exemplary base station 300 according to various exemplary embodiments. The base station 300 may represent the gNB 120A or any other type of access node through which the UE 110 may establish a connection and manage network operations.

The base station 300 may include a processor 305, a memory arrangement 310, an input/output (I/O) device 315, a transceiver 320, and other components 325. The other components 325 may include, for example, an audio input device, an audio output device, a battery, a data acquisition device, ports to electrically connect the base station 300 to other electronic devices and/or power sources, transceiver chains, antenna elements, etc.

The processor 305 may be configured to execute software for the base station 300. For example, the software may be configured to perform operations such as, but not limited to, scheduling downlink traffic and transmitting downlink packets to the UE 110.

The software being executed by the processor 305 is only exemplary. The functionality associated with the software may also be represented as a separate incorporated component of the base station 300 or may be a modular component coupled to the base station 300, e.g., an integrated circuit with or without firmware. For example, the integrated circuit may include input circuitry to receive signals and processing circuitry to process the signals and other information. In addition, in some base stations, the functionality described for the processor 305 is split among a plurality of processors (e.g., a baseband processor, an applications processor, etc.). The exemplary embodiments may be implemented in any of these or other configurations of a base station.

The memory 310 may be a hardware component configured to store data related to operations performed by the base station 300. The I/O device 315 may be a hardware component or ports that enable a user to interact with the base station 300.

The transceiver 320 may operate on a variety of different frequencies or channels (e.g., set of consecutive frequencies). Therefore, the transceiver 320 may include one or more components (e.g., radios) to enable the data exchange with the various networks and UEs. The transceiver 320 includes circuitry configured to transmit and/or receive signals (e.g., control signals, data signals). Such signals may be encoded with information implementing any one of the methods described herein. The processor 305 may be operably coupled to the transceiver 320 and configured to receive from and/or transmit signals to the transceiver 320. The processor 305 may be configured to encode and/or decode signals (e.g., signaling from a UE) for implementing any one of the methods described herein.

According to some aspects, the exemplary embodiments introduce a SRQ timer. As will be described in more detail below, a single SRQ timer may be used by the UE 110 to manage multiple QoS rules for reflective QoS. This is in contrast to schemes that may use a single reflective QoS timer for maintaining a single QoS rule.

The exemplary SRQ timer is described as being used in conjunction with a shortest timer first (STF) list. The STF list may be used to track when QoS rules are set to expire relative to a single SRQ timer. However, reference to the terms SRQ timer and STF list are merely provided for illustrative purposes. Different entities may refer to similar concepts by a different name.

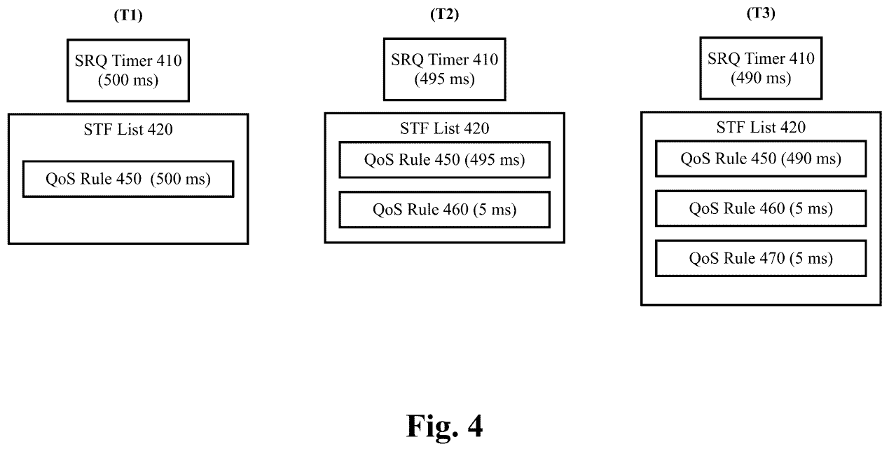

FIG. 4 shows an example 400 of utilizing an SRQ timer and an STF list for QoS rule management according to various exemplary embodiments. The example 400 is not intended to limit the exemplary embodiments in any way. Instead, the example, 400 is provided to illustrate some general exemplary aspects of the SRQ timer and STF list introduced herein.

In the example 400 it is assumed that each QoS rule is configured to timeout at 500 milliseconds (ms). However, reference to each QoS rule being configured with a timeout of 500 ms is merely provided for illustrative purposes. The exemplary embodiments are not required to use QoS rules that have a same timeout value and may utilize QoS rules configured with any appropriate timeout value.

The example 400 shows a SRQ timer 410 and a STF list 420 at three different instances of time T1-T3. At a first time (T1), the UE 110 receives a first downlink packet and derives a first QoS rule 450. The UE 110 may then initiate the SRQ timer 410 and set the SRQ timer to expire in 500 ms. In addition, the UE 110 may add the first QoS rule 450 to the STF list 420 with an indication of when the QoS rule 450 is set to timeout (e.g., 500 ms).

At a second time (T2), the UE 110 receives a second downlink packet and derives a second different QoS rule 460. In the example 400, the second downlink packet is received 5 ms after T1 (T1−5 ms=T2) and thus, the SRQ timer 410 is set to 495 ms at T2. Like the first QoS rule 450, the second QoS rule 460 has a timeout value of 500 ms. The UE 110 adds the second QoS rule 460 to the STF list 420. In addition, the UE 110 may store an indication that the second QoS rule 460 is set to timeout 5 ms after the first QoS Rule 450.

As indicated above, the STF list may be used to track the timeout status of one QoS rule relative to at least one other QoS rule. In the example 400, the UE 110 tracks when QoS rule 460 is set to timeout based on the status of QoS rule 450 which is currently aligned with the SRQ timer 410. This allows a single SRQ timer 410 to be utilized to manage multiple QoS rules, e.g., QoS rules 450-460.

At a third time (T3), the UE 110 receives a third downlink packet and derives a third QoS rule 470. In the example 400, the third downlink packet is received 10 ms after T1 (T1 10 ms=T3) and thus, the SRQ timer is set to 490 ms at T3. Like QoS rules 450-460, the third QoS rule 470 is set to timeout at 500 ms. The third QoS rule 470 may be added to the STF list 420 with an indication that the third QoS rule 470 is set to timeout 5 ms after the second QoS Rule 460.

In some embodiments, the UE 110 may track when a QoS rule is configured to timeout based on the timeout value of the QoS rule and the sum of the timeout parameters for the previous entries of the STF list. For example, at T3, QoS rule 470 has a timeout value of 500 ms, QoS rule 450 is set to expire in 490 ms and QoS rule 460 is set to expire 5 ms after QoS rule 450.

Therefore, to calculate when QoS rule 470 is set to expire relative to the other entries of the STF list 420 the following calculation may be performed: QoS rule 470 timeout=500 ms (e.g., the timeout value for QoS rule 470)−(490 ms (e.g., (e.g., the timeout value for QoS rule 450)+5 ms (e.g., the timeout value for QoS rule 460))=5 ms.

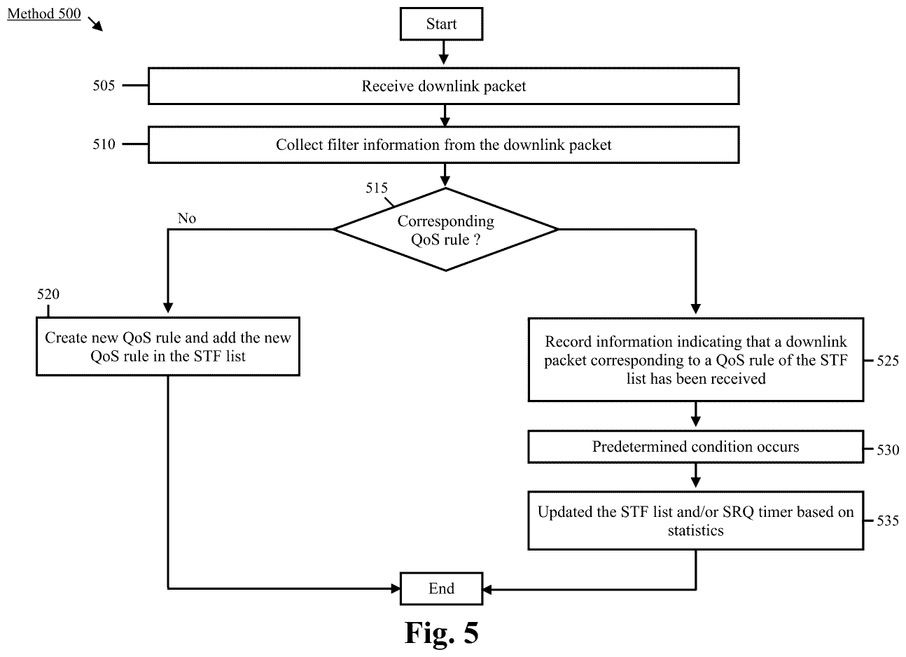

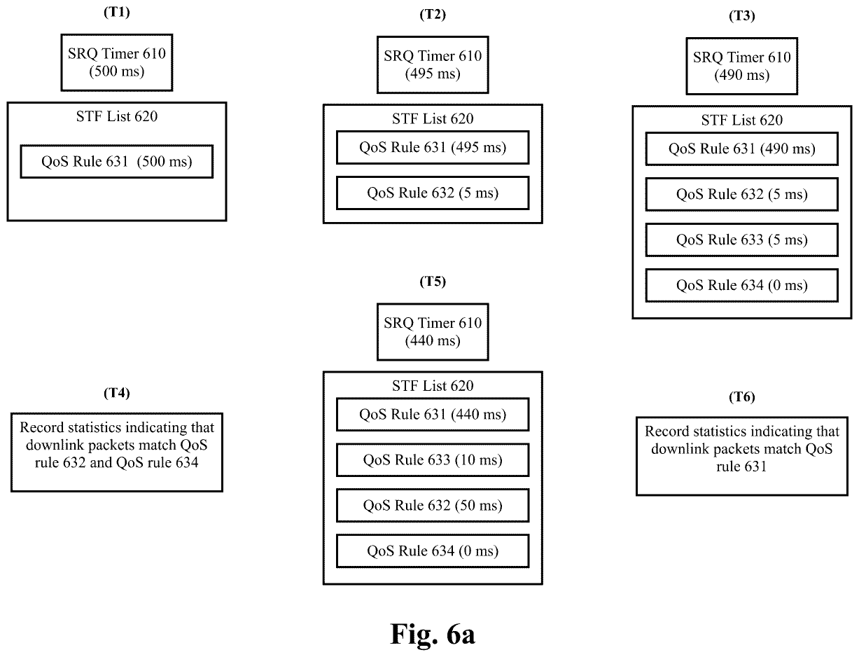

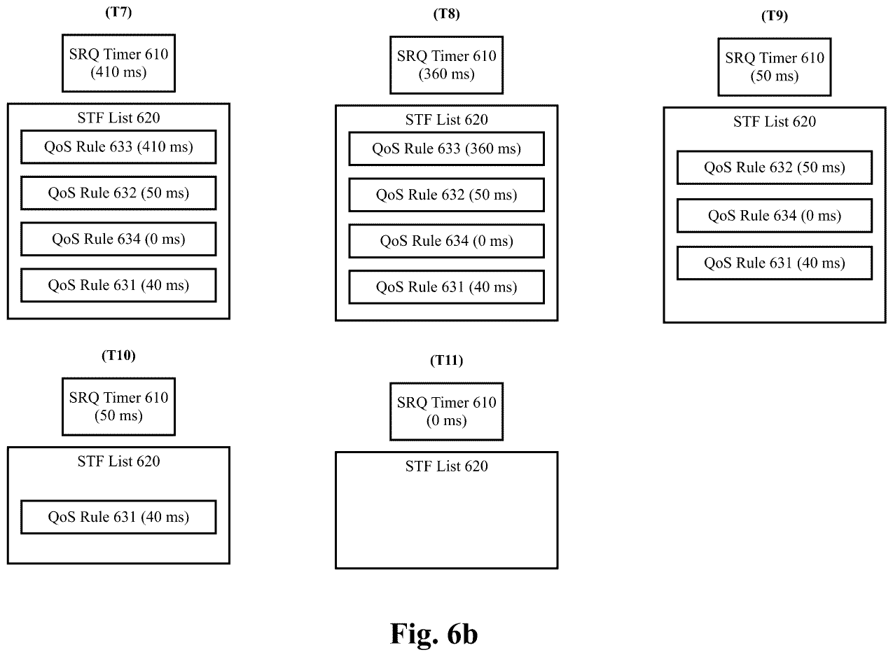

As mentioned above, the STF list may track the timeout status of one QoS rule relative to at least one other QoS rule. In the example 400, the UE 110 tracks when QoS rule 470 is set to timeout based on QoS rules 450 and 460. This allows a single SRQ timer 410 to be utilized to manage multiple QoS rules, e.g., QoS rules 450-470. The example 400 is not intended to limit the exemplary embodiments in any way and is provided as a general overview to illustrate an example of the relationship between different entries of an STF list and the SRQ timer. An example of processing downlink packets for reflective QoS and operating the SRQ timer and STF list to manage QoS rules is provided below with regard to the method 500 of FIG. 5. After the method 500, the example 600 of FIGS. 6a-6b provide another example illustrating the relationship between entries of the STF list and the SRQ timer at different time instances.

In addition to the SRQ timer and STF list, the UE 110 may record statistics per QoS rule in a local database to track the corresponding downlink activity per QoS rule. The UE 110 may then periodically or occasionally check the statistics and adjust the STF list and/or the SRQ timer value based on the statistics. To provide a general example within the context of the example 400, if QoS rule 460 is identified from downlink traffic after T3, the UE 110 may store and indication that QoS rule 460 has been received. The UE 110 may then wait until a trigger condition causes the UE 110 to check the statistics and determine whether to adjust the STF list and/or the SRQ timer value based on the statistics. In some embodiments, the trigger condition may be the expiry of an exemplary periodic reflective QoS timer. However, reference to statistics and a periodic reflective QoS timer are merely provided for illustrative purposes. Different entities may refer to similar concepts by a different name.

FIG. 5 shows a method 500 for processing downlink packets according to various exemplary embodiments. The method 500 is described from the perspective of the UE 110.

Initially, assume a scenario in which the UE 110 is configured with one or more packet data unit (PDU) sessions. During PDU session establishment or modification, the UE 110 may indicate that the UE 110 supports reflective QoS for a particular PDU session.

In 505, the UE 110 receives a downlink packet from the network. In accordance with reflective QoS, the downlink packet may provide the basis for the UE 110 to derive the QoS rule for uplink traffic. In some embodiments, the network may include a reflective QoS indication (RQI) to indicate that a downlink packet is to be used for reflective QoS.

In 510, the UE 110 collects filter information from the downlink packet. In 515, the UE 110 determines whether the filter information corresponds to a QoS rule already stored in the STF list. If a corresponding QoS rule is not currently stored in the STF list, the method 500 continues to 520.

In 520, the UE 110 creates a new QoS rule and adds the new QoS rule to the STF list. The STF list may comprise the QoS rules that are to be used for reflective QoS. When the UE 110 adds a QoS rule to the STF list, the QoS rule is configured for reflective QoS. When the UE 110 removes the QoS rule from the STF list, the QoS rule is no longer configured for reflective QoS.

If the new QoS rule is the first QoS rule to be stored in the STF list, the SRQ timer may be initiated with a timer value that is set to the timeout value for the new QoS rule. To provide an example within the context of the example 400, the QoS rule may be configured with a timeout value of 500 ms and thus, the SRQ timer may be set to 500 ms. If the new QoS rule is not the first QoS rule to be added to the STF list, the SRQ timer is already running and the timeout status of new QoS rule may be tracked relative to at least one other QoS rule of the STF list.

As will be described in more detail below with regard to the example 600 of FIGS. 6a-6b, the STF list may be comprises of (N) QoS rules. The first node of the STF list may contain the QoS rule with the shortest timeout value and the subsequent nodes (e.g., entries) of the STF list may have a timeout value based on the previous nodes of the STF list.

Returning to 515, if the QoS rule identified from the downlink packet is already stored in the STF list, the method 500 continues to 525. In 525, the UE 110 records information indicating that a downlink packet corresponding to a QoS rule of the STF list has been received. For example, the UE 110 may store statistics indicating that filter information corresponding to a first QoS rule (QoS Rule X) was received at time (T). As will be described in more detail below, the UE 110 may use the QoS rule statistics to adjust the STF list and/or SRQ timer.

In 530, a predetermined condition occurs. The predetermined condition may trigger the UE 110 to determine whether the STF list and/or SRQ timer is to be adjusted based on the statistics. In this example, it is assumed that the STF list and/or SRQ timer is to be adjusted. However, in an actual deployment scenario, the UE 110 may be triggered to check the statistics and determine that neither the STF list and/or SRQ timer is to be adjusted.

In 535, the UE 110 updates the STF list and/or SRQ timer based on the recorded information. For example, the information recorded by the UE 110 in 525 may be stored as part of QoS rule hit statistics in a local database. The QoS rule hit statistics may comprise information indicating that downlink packets matching QoS rules already stored in the STF list have been received by the UE 110. This information may then be used to calculate when QoS rules are to timeout and adjust the STF list accordingly.

In some embodiments, the predetermined condition in 530 may be the expiration of a periodic reflective QoS timer. In contrast to the SRQ timer, the periodic reflective QoS timer introduced herein is not used to track the timeout status of any of the rules in the STF list. Instead, the UE 110 may utilize a periodic reflective QoS timer to trigger the UE 110 to periodically check the recorded statistics of the downlink activity per QoS rule.

In other embodiments, the predetermined condition in 530 may be the expiration of the SRQ timer. For example, the STF list may include multiple QoS rules configured to timeout at different times. A timeout for first QoS rule of the STF list may align with the SRQ timer while the timeout status for the other QoS rules of the STF list are tracked relative to the first QoS rule. When the SRQ timer expires, the UE 110 may delete the first QoS rule from the STF list, adjust the remaining QoS rules of the STF list based on the statistics (if necessary) and then set the SRQ timer to align with the timeout of one or more QoS rules remaining on the STF list.

The exemplary embodiments are not limited to a predetermined condition that is based on the expiry of the SRQ timer or the expiry of a periodic reflective QoS timer. The exemplary embodiments may utilize any appropriate condition to trigger the UE 110 to check the statistics and determine whether to adjust the STF list and/or SRQ timer.

505-525 of the method 500 are described within the context of processing a single downlink packet. In an actual operating scenario, multiple downlink packets may be processed prior to the occurrence of the predetermined condition in 530. The UE 110 may maintain statistics per QoS rule to track downlink activity per QoS rule and thus, when the predetermined condition occurs in 530 there may be statistics corresponding to multiple QoS rules.

FIGS. 6a-6b show an example 600 of utilizing the SRQ timer and the STF list for QoS rule management according to various exemplary embodiments. Like the example 400, in the example 600 it is assumed that each QoS rule is configured to timeout at 500 ms. However, reference to each QoS rule being configured to timeout at 500 ms is merely provided for illustrative purposes. QoS rules are not required to have a same timeout value and may utilize any appropriate timeout value.

The example 600 shows a SRQ timer 610 and a STF list 620 at eleven different times T1-T11. FIG. 6a includes T1-T6 and FIG. 6b includes T7-T11. At a first time (T1), the UE identifies a first QoS rule 631 from downlink traffic. The UE 110 may set the SRQ timer 610 to expire in 500 ms and add QoS rule 631 to the STF list 620.

At a second time (T2), the UE 110 identifies a second QoS rule 632 from traffic. In the example 600, the second QoS rule was received 5 ms after T1 (T1−5 ms=T2) and thus, the SRQ timer is set to 495 ms at T2. Like the first QoS rule 631, the second QoS rule 632 is set to timeout at 500 ms. Accordingly, the second QoS rule 632 is added to the STF list 620 with an indication that the second QoS rule 632 is set to timeout 5 ms after the first QoS Rule 631.

At a third time (T3), the UE 110 identifies a third QoS rule 633 and a fourth QoS rule 634 from downlink traffic. In the example 600, the QoS rules 633-634 were received 10 ms after T1 (T1−10 ms=T3) and thus, the SRQ timer is set to 490 ms at T3. In some embodiments, the downlink packets for QoS rules 633-634 are not actually received at the same time but the time difference is small enough for the UE 110 to consider them to be received at the same time. For example, the UE 110 may track the reception of downlink packets matching QoS rules at a 1 ms granularity. Thus, if one downlink packet is received within 1 ms of another downlink packet these two packets may be considered to be received at the same time for QoS rule management. However, reference to a 1 ms granularity is merely provided for illustrative purposes, the UE 110 may utilize any appropriate duration of time to consider two or more packets to be received at approximately the same time.

As described above with regard to the example 400 of FIG. 4, in some embodiments, the UE 110 may track when a QoS rule is configured to timeout based on the timeout value of the QoS rule and the sum of the timeout parameters for the previous entries of the STF list. In example 600, at T3, QoS rule 633 has a timeout value of 500 ms, QoS rule 430 is set to expire in 490 ms and QoS rule 432 is set to expire 5 ms after QoS rule 430. Therefore, to calculate when QoS rule 633 is set to expire relative to the other entries of the STF list 620 the following calculation may be performed: QoS rule 633 timeout=500 ms (e.g., the timeout value for QoS rule 633)−(490 ms (e.g., (e.g., the timeout value for QoS rule 631)+5 ms (e.g., the timeout value for QoS rule 632) )=5 ms.

Since QoS rule 634 and QoS rule 633 are identified at the same time, both QoS rules are set to timeout at the same time. From the perspective of managing the STF list 620, to calculate when QoS rule 634 is set to expire relative to the other entries of the STF list 620 the following calculation may be performed: QoS rule 634 timeout=500 ms (e.g., the timeout value for QoS rule 633)−(490 ms (e.g., (e.g., the timeout value for QoS rule 631)+5 ms (e. g., the timeout value for QoS rule 632)+5 ms (e.g. the timeout value for QoS rule 633) )=0 ms. Thus, relative to QoS rule 633, the QoS rule 634 is set to timeout at the same time (e.g., 0 ms difference).

At a fourth time (T4), the UE 110 identifies QoS rules 632 and 634 from downlink traffic. Since QoS rules 632 and 634 are already stored in the STF list 620, the UE 110 records statistics indicating that downlink packets match QoS rules 632 and 634. At this time, the UE 110 does not make any adjustments to the STF list 620 or the SRQ timer 610.

At a fifth time (T5), a periodic reflective QoS timer expires. As indicated above, this may trigger the UE 110 to check stored statistics for downlink activity per QoS rule to recalculate the SRQ timer 610 and/or STF list 620. In this example, it is assumed that the periodic reflective QoS timer is set to expire every 50 ms. However, reference to periodic reflective QoS timer being configured with a timeout of 50 ms is merely provided for illustrative purposes. The exemplary embodiments may utilize a periodic reflective QoS timer configured with any appropriate timeout value and/or any other appropriate condition.

T5 occurs 50 ms after T3 and thus, the SRQ timer 610 is set to 440 ms at T5. In addition, the UE 110 has adjusted the STF list 620 based on the stored statistics from T4. Since there are no statistics related to QoS rule 631, QoS rule 631 remains aligned with the SRQ timer 410. Similarly, since there are no statistics related to QoS rule 633 remains set to timeout 10 ms after QoS rule 631.

At T5, the STF list 620 shows that QoS rules 632 and 634 have been adjusted to reflect their new timeout value. To calculate when QoS rule 632 is set to expire relative to the other entries of the STF list 620 the following calculation may be performed: QoS rule 632 timeout=500 ms (e.g., the timeout value for QoS rule 632)−(440 ms (e.g., (e.g., the timeout value for QoS rule 631) +10 ms (e.g., the timeout value for QoS rule 633))=50 ms. Thus, the QoS rule 632 is set to timeout 50 ms after QoS rule 633.

To calculate when QoS rule 634 is set to expire relative to the other entries of the STF list 620 the following calculation may be performed: QoS rule 634 timeout=500 ms (440 ms+10 ms+50 ms (e.g., the timeout value for QoS rule 632))=0 ms. Thus, the QoS rule 632 is set to timeout 0 ms after QoS rule 632.

At a sixth time (T6), the UE 110 identifies QoS rule 631 from downlink traffic. Since QoS rule 631 is already stored in the STF list 620, the UE 110 records statistics related to QoS rules 631. The UE 110 may then update the STF list accordingly where QoS rule 631 may be set to expire in 500 ms, QoS rule 633 may be set to expire in 410 ms, QoS rule 632 may be set to expire 50 ms after QoS rule 633, QoS rule 634 may be set to expire 0 ms after QoS rule 632 and QoS rule 631 may be set to expire 40 ms after QoS rule 632.

At a seventh time (T7), the periodic reflective QoS timer expires, and the UE 110 is triggered to adjust the STF list 620 based on the statistics stored at T6. In this example, T7 occurs 50 ms after T5. Since QoS rule 631 is adjusted based on the statistics, the SRQ timer 610 is adjusted to align with QoS rule 633, e.g., 410 ms. In addition, to calculate the new timeout value for QoS rule 631 for the STF list 620 the following calculation may be performed: QoS rule 631 timeout=500 ms−(410 ms+50 ms+0 ms)=40 ms. Thus, the QoS rule 631 is set to timeout 40 ms after QoS rule 634.

At an eighth time (T8), the periodic reflective QoS timer expires, and the UE 110 is triggered to determine whether the SRQ timer 610 and/or the STF list 620 is to be adjusted based on statistics. In this example, T8 occurs 50 ms after T7 and the SRQ timer 610 is set to 360 ms at T8. Since there were no downlink packets received for any of the QoS rules in the STF list 620 between T7 and T8, neither the SRQ timer 610 nor the STF list 620 are adjusted based on statistics.

After T8, no downlink packets for any of the QoS rules in the STF list 620 are received. Accordingly, at a ninth time (T9) which occurs 360 ms after T8, the SRQ timer 610 expires, and the UE 110 removes the QoS rule 633 from the STF list 620. The UE 110 then updates the SRQ timer 610 to align with the next QoS rule 632 (e.g., 50 ms).

In between T8 and T9, the UE 110 may have been triggered to check statistics based on the periodic reflective QoS timer. However, since no downlink packets for any of the QoS rules in the STF list 620 were received, this event is not shown in the example 600.

After T9, no downlink packets for any of the QoS rules in the STF list 620 are received. Accordingly, at a tenth time (T10) which occurs 50 ms after T9, the SRQ timer 610 expires, and the UE 110 removes the QoS rules 632 and 634 from the STF list 620. The UE 110 then updates the SRQ timer 610 to align with the next QoS rule 632 (e.g., 50 ms).

After T10, no downlink packets for any of the QoS rules in the STF list 620 are received. Accordingly, at an eleventh time (T11) which occurs 50 ms after T10, the SRQ timer 610 expires, and the UE 110 removes the QoS rule 631 from the STF list 620.

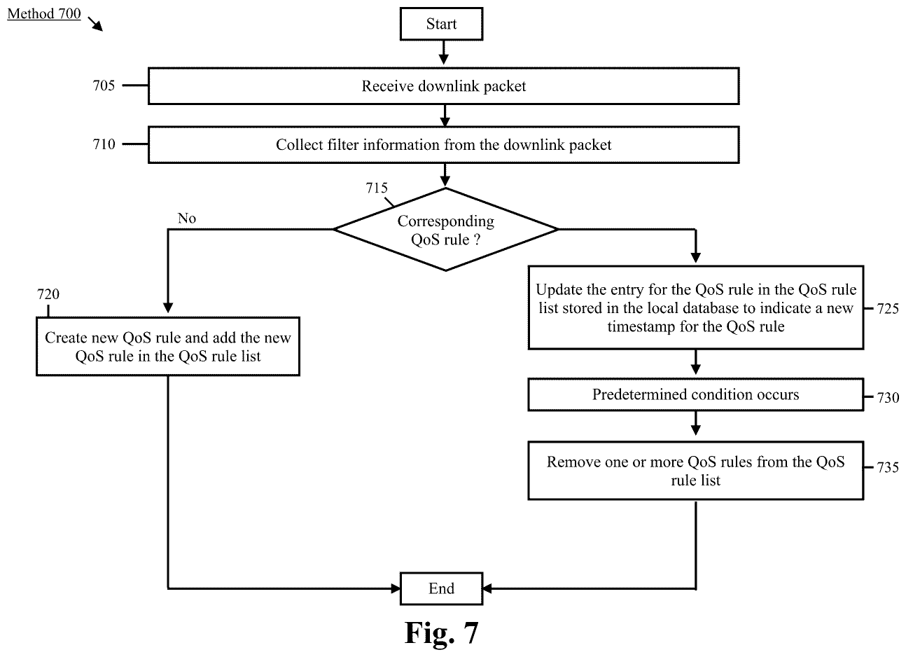

According to other aspects, the exemplary embodiments introduce a timestamp-based approach for QoS rule management. FIG. 7 shows a method 700 for a timestamp-based approach for QoS management. The method 700 is described from the perspective of the UE 110 of the network arrangement 100 of FIG. 1.

Initially, assume a scenario in which the UE 110 is configured with one or more PDU sessions. During PDU session establishment or modification, the UE 110 may indicate that the UE 110 supports reflective QoS for a particular PDU session.

In 705, the UE 110 receives a downlink packet from the network. In accordance with reflective QoS, the downlink packet may provide the basis for the UE 110 to derive the QoS rule for uplink traffic. In some embodiments, the network may include a RQI to indicate that a downlink packet is to be used for reflective QoS.

In 710, the UE 110 collects filter information from the downlink packet. In 715, the UE 110 determines whether the filter information corresponds to a QoS rule already stored in a local database. If a corresponding QoS rule is not currently stored in the local database, the method 700 continues to 720.

In 720, the UE 110 creates a new QoS rule and adds the new QoS rule to the QoS list stored in the local database with a timestamp indicating when the QoS rule was identified from downlink traffic.

Returning to 715, if the QoS rule identified from the downlink packet is already stored in the local database, the method 700 continues to 725. In 725, the UE 110 updates the entry for the QoS rule in the QoS rule list stored the local database to indicate a new timestamp for the QoS rule.

In 730, a predetermined condition occurs. The predetermined condition may trigger the UE 110 to check whether any of the QoS rules of the QoS rules list are to be removed due to timeout. For example, the UE 110 may retrieve a current timestamp in response to the predetermined condition. The UE 110 may then compare the current timestamp to a last received timestamp for a QoS rule stored in the QoS rule list. If the current timestamp minus the last received timestamp stored with the QoS rule in the QoS rule list is greater than a timeout threshold value (current timestamp−last received timestamp>timestamp threshold value), the corresponding QoS rule may be removed from the local database. Otherwise (current timestamp last received timestamp<timestamp threshold value), the QoS rule may remain in the local database. The UE 110 may perform this comparison for every rule stored in the QoS Rule list or for a subset of the QoS rules of the QoS list in response to the predetermined condition.

In this example, it is assumed that the at least one QoS rule was determined to timeout. Accordingly, in 735, the UE 110 removes one or more QoS rules from the QoS rule list. However, as indicated above, in an actual operating scenario the UE 110 may determine that none of the QoS rules have timed out and thus, none of the QoS rules may be removed from the QoS rule list.

In some embodiments, the predetermined condition in 730 may be the expiration of a periodic reflective QoS timer. In this example, the periodic reflective QoS timer is not used to track the timeout status of any of the rules stored in the local database. Instead, the UE 110 may utilize the periodic reflective QoS timer to trigger the UE 110 to periodically compare a current timestamp to one or more timestamps stored in the local database. However, the exemplary embodiments are not limited to a predetermined condition that is based on the expiry of the periodic reflective QoS timer. The exemplary embodiments may utilize any appropriate condition to trigger the UE 110 to compare a current timestamp to one or more timestamps stored in the local database.

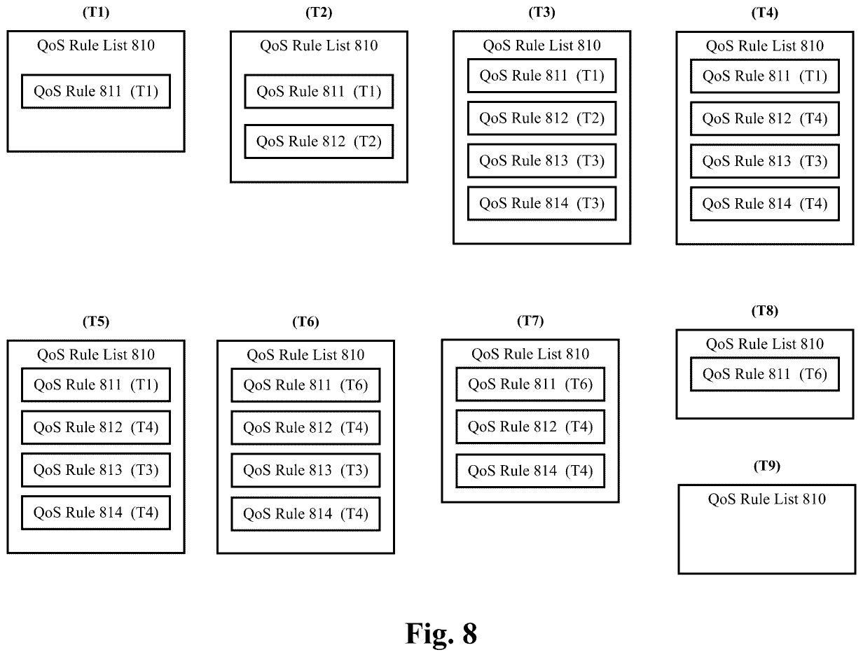

FIG. 8 shows an example 800 of managing a QoS rule list using a timestamp-based approach according to various exemplary embodiments.

The example 800 shows a QoS rule list 810 at nine different times T1-T9. In this example it is assumed that a timeout threshold value for each QoS rule is configured at 500 ms. However, reference to each QoS rule being configured with a 500 ms timeout threshold value is merely provided for illustrative purposes. QoS rules are not required to have a same timeout threshold value and the exemplary embodiments may utilize any appropriate timeout threshold value.

At a first time (T1), the UE identifies a first QoS rule 811 from downlink traffic and stores the QoS rule 811 in the QoS rule list 810 with a timestamp of T1. At a second time (T2), the UE 110 identifies a second QoS rule 812 from downlink traffic and stores the QoS rule 812 in the QoS rule list 810 with a timestamp of T2. At a third time (T3), the UE 110 identifies a third QoS rule 813 and a fourth QoS rule 814 from downlink traffic. The UE 110 stores the QoS rule 813 in the QoS rule list 810 with a timestamp of T3 and the QoS rule 814 in the QoS rule list 810 with a timestamp of T3.

At a fourth time (T4), the UE 110 identifies the second QoS rule 812 and the fourth QoS rule 814 from downlink traffic. The UE 110 updates the timestamp of QoS rule 812 from T2 to T4 and the timestamp of QoS rule 814 from T3 to T4 in the QoS rule list 810.

At a fifth time (T5), a periodic reflective QoS timer expires. This triggers the UE 110 to retrieve a current timestamp and compare the current timestamp to the timestamps for each QoS rule (e.g., T1, T3, T4). When the current timestamp minus a last received timestamp (e.g., T1, T3, T4) is greater than the timeout threshold value, the UE 110 may remove the corresponding rule from the QoS rule list 810 stored in the local database. However, in this example, none of the QoS rules are considered to have expired after this comparison at T5.

At a sixth time (T6), the UE 110 identifies the first QoS rule 811 from downlink traffic. The UE 110 then updates the timestamp for QoS rule 811 from T1 to T6 in the QoS rule list 810. The UE 110 does not receive any downlink packets for the QoS rules after T5.

At a seventh time (T7), the periodic reflective QoS timer expires. This triggers the UE 110 to retrieve a current timestamp and compare the current timestamp to the timestamps for each QoS rule (e.g., T5, T3, T4). When the current timestamp minus a last received timestamp (e.g., T5, T3, T4) is greater than the timeout threshold value, the UE 110 may remove the corresponding rule from the QoS rule list stored in the local database. In this example, T7−T3 is greater than the timeout threshold value. Accordingly, the UE 110 removes the corresponding QoS rule 813 from the QoS rule list 810 stored in the local database.

At an eight time (T8), the periodic reflective QoS timer expires. This triggers the UE 110 to retrieve a current timestamp and compare the current timestamp to the timestamps for each QoS rule (e.g., T5, T4). When the current timestamp minus a last received timestamp (e.g., T5, T4) is greater than the timeout threshold value, the UE 110 may remove the corresponding rule from the QoS rule list stored in the local database. In this example, T8−T4 is greater than the timeout threshold value. Accordingly, the UE 110 removes the corresponding QoS rule 812 and QoS rule 814 from the QoS rule list 810 stored in the local database.

At a ninth time (T9), the periodic reflective QoS timer expires. This triggers the UE 110 to retrieve a current timestamp and compare the current timestamp to the timestamps for each QoS rule (e.g., T5). When the current timestamp minus a last received timestamp (e.g., T5) is greater than the timeout threshold value, the UE 110 may remove the corresponding rule from the QoS rule list 810 stored in the local database. In this example, T9−T5 is greater than the timeout threshold value. Accordingly, the UE 110 removes the corresponding QoS rule 811 and QoS rule 814 from the QoS list 810 stored in the local database.

### EXAMPLES

In a first example, a method is performed by a user equipment (UE), comprising deriving a first quality of service (QoS) rule for reflective QoS based on received downlink traffic, adding the first QoS rule to a list of at least one QoS rules, wherein the list is associated with a timer and the timer is configured to indicate when a QoS rule timeout has occurred, deriving a second QoS rule for reflective QoS based on the received downlink traffic and adding the second QoS rule to the list, wherein the second QoS rule is associated with a timeout value that is defined relative to one or more QoS rules included in the list.

In a second example, the method of the first example, wherein a timeout value for the first QoS rule is aligned with a current timer value of the timer and wherein a timeout value for the second QoS rule is defined relative to the first QoS rule and configured to timeout after the timer expires.

In a third example, the method of the second example, further comprising, when the timer expires, removing the first QoS rule from the list and updating the timer to align with a timeout value for the second QoS rule.

In a fourth example, the method of the first example, further comprising receiving, after adding the first QoS rule to the list, subsequent downlink traffic, identifying the first QoS rule from the subsequent downlink traffic, determining statistics comprising an indication that the first QoS rule has been identified from the subsequent downlink traffic and updating the list based on the statistics.

In a fifth example, the method of the fourth example, further comprising wherein prior to receiving the subsequent downlink traffic, a timeout value for the first QoS rule is aligned with a current timer value of the timer and a timeout value for the second QoS rule is defined relative to the first QoS rule and configured to timeout after the timer expires, and wherein after updating the list based on the statistics, the timeout value for the second QoS rule is aligned with the current time value of the timer and the timeout value for the first QoS rule is defined relative to the second QoS rule and configured to timeout after the timer expires.

In a sixth example, the method of the fourth example, further comprising identifying a predetermined condition, wherein updating the list based on the statistics is performed in response to identifying the predetermined condition.

In a seventh example, the method of the sixth example, wherein a second different timer is configured to trigger the UE to periodically check whether the list is to be updated based on statistics and wherein the predetermined condition is the expiry of the second different timer.

In an eighth example, the method of the first example, further comprising determining statistics comprising at least one indication that subsequent downlink traffic includes a downlink packet that matches a QoS rule currently stored in the list and updating the list based on the statistics.

In a ninth example, the method of the eighth example, further comprising identifying a predetermined condition, wherein updating the list based on the statistics is performed in response to identifying the predetermined condition.

In a tenth example, the method of the ninth example, wherein the predetermined condition is an expiry of the timer.

In an eleventh example, the method of the first example, wherein the list of at least one QoS rules is stored in a local database.

In a twelfth example, a processor configured to perform any of the methods of the first through eleventh examples.

In a thirteenth example, a user equipment (UE) comprising a transceiver configured to communicate with a network and a processor communicatively coupled to the transceiver and configured to perform any of the methods of the first through eleventh examples.

In a fourteenth example, a method is performed by a user equipment (UE), comprising deriving a first quality of service (QoS) rule for reflective QoS based on received downlink traffic and adding the first QoS rule to a list of at least one QoS rules with a timestamp for the first QoS rule, wherein the list comprises one or more QoS rules each with a respective timestamp and none of the one or more QoS rules are associated with a timer configured to indicate when a timeout has occurred.

In a fifteenth example, the method of the fourteenth example further comprising receiving, after adding the first QoS rule to the list, subsequent downlink traffic, identifying the first QoS rule from the subsequent downlink traffic and updating the timestamp for the first QoS rule in response to identifying the first QoS rule from the subsequent downlink traffic.

In a sixteenth example, the method of the fourteenth example, further comprising identifying a predetermined condition and updating the list in response to identifying the predetermined condition.

In a seventeenth example, the method of the sixteenth example, wherein the predetermined condition is an expiry of a timer.

In an eighteenth example, the method of the sixteenth example, further comprising calculating a difference between a current timestamp and the timestamp of the first QoS rule and determining that the difference between the current timestamp and the timestamp of the first QoS rule is greater than a threshold value.

In a nineteenth example, the method of the eighteenth example, wherein updating the list comprises deleting the first QoS rule from the list based on the difference between the current timestamp and the timestamp of the first QoS rule being greater than the threshold value.

In a twentieth example, a processor configured to perform any of the methods of the fourteenth through nineteenth examples.

In a twenty first example, a user equipment (UE) comprising a transceiver configured to communicate with a network and a processor communicatively coupled to the transceiver and configured to perform any of the methods of the fourteenth through nineteenth examples.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. The exemplary embodiments of the above-described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. An apparatus of a user equipment (UE), the apparatus comprising processing circuitry configured to:
derive a first quality of service (QoS) rule for reflective QoS based on received downlink traffic;
add the first QoS rule to a list of at least one QoS rule, wherein the list is associated with a timer and the timer is configured to indicate when a QoS rule timeout has occurred;
derive a second QoS rule for reflective QoS based on the received downlink traffic; and
add the second QoS rule to the list, wherein the second QoS rule is associated with a timeout value that is defined relative to one or more QoS rules included in the list.

2. The apparatus of claim 1, wherein a timeout value for the first QoS rule is aligned with a current timer value of the timer and wherein a timeout value for the second QoS rule is defined relative to the first QoS rule and configured to timeout after the timer expires.

3. The apparatus of claim 2, wherein the processing circuitry is further configured to:
remove the first QoS rule from the list when the timer expires; and
update the timer to align with the timeout value for the second QoS rule.

4. The apparatus of claim 1, wherein the processing circuitry is further configured to:
decode, based on signals received from a base station, subsequent downlink traffic received after adding the first QoS rule to the list;
identify the first QoS rule from the subsequent downlink traffic;
determine statistics comprising an indication that the first QoS rule has been identified from the subsequent downlink traffic; and
update the list based on the statistics.

5. The apparatus of claim 4, wherein the processing circuitry is further configured to:
wherein prior to receiving the subsequent downlink traffic, a timeout value for the first QoS rule is aligned with a current timer value of the timer and a timeout value for the second QoS rule is defined relative to the first QoS rule and configured to timeout after the timer expires, and
wherein after updating the list based on the statistics, the timeout value for the second QoS rule is aligned with the current time value of the timer and the timeout value for the first QoS rule is defined relative to the second QoS rule and configured to timeout after the timer expires.

6. The apparatus of claim 4, wherein the processing circuitry is further configured to:
identify a predetermined condition, wherein updating the list based on the statistics is performed in response to identifying the predetermined condition.

7. The apparatus of claim 6, wherein a second different timer is configured to trigger the UE to periodically check whether the list is to be updated based on statistics and wherein the predetermined condition is an expiration of the second different timer.

8. The apparatus of claim 1, wherein the processing circuitry is further configured to:
determine statistics comprising at least one indication that subsequent downlink traffic includes a downlink packet that matches a QoS rule currently stored in the list; and
update the list based on the statistics.

9. The apparatus of claim 8, wherein the processing circuitry is further configured to:
identify a predetermined condition, wherein updating the list based on the statistics is performed in response to identifying the predetermined condition.

10. The apparatus of claim 9, wherein the predetermined condition is an expiry of the timer.

11. The apparatus of claim 1, wherein the list of at least one QoS rules rule is stored in a local database.

12. An apparatus of a user equipment (UE), the apparatus comprising processing circuitry configured to:
derive a first quality of service (QoS) rule for reflective QoS based on received downlink traffic; and
add the first QoS rule to a list of at least one QoS rule with a timestamp for the first QoS rule, wherein the list comprises one or more QoS rules each with a respective timestamp and none of the one or more QoS rules are associated with a timer configured to indicate when a timeout has occurred.

13. The apparatus of claim 12, wherein the processing circuitry is further configured to:
decode, based on signals received from a base station, subsequent downlink traffic received after adding the first QoS rule to the list;
identify the first QoS rule from the subsequent downlink traffic; and
update the timestamp for the first QoS rule in response to identifying the first QoS rule from the subsequent downlink traffic.

14. The apparatus of claim 12, wherein the processing circuitry is further configured to:
identify a predetermined condition; and
update the list in response to identifying the predetermined condition.

15. The apparatus of claim 14, wherein the predetermined condition is an expiration of the timer.

16. The apparatus of claim 14, wherein the processing circuitry is further configured to:
calculate a difference between a current timestamp and the timestamp of the first QoS rule; and
determine that the difference between the current timestamp and the timestamp of the first QoS rule is greater than a threshold value.

17. The apparatus of claim 16, wherein updating the list comprises deleting the first QoS rule from the list based on the difference between the current timestamp and the timestamp of the first QoS rule being greater than the threshold value.
